(19) United States
(12) Patent Application Publication
(10) Pub. No.: US 2013/0181519 A1
(43) Pub. Date: Jul. 18, 2013

(54) POWER CONVERSION SYSTEM FOR ENERGY STORAGE SYSTEM AND CONTROLLING METHOD OF THE SAME

(71) Applicant: Woog-Young Lee, Yongin-si (KR)

(72) Inventor: Woog-Young Lee, Yongin-si (KR)

(21) Appl. No.: 13/822,629

(22) PCT Filed: Oct. 28, 2010
(86) PCT No.: PCT/KR10/07490

§ 371 Date: Mar. 12, 2013

(30) Foreign Application Priority Data
Oct. 1, 2010 (US) 61389083

(51) Int. Cl. H02J 3/38

(52) U.S. Cl. CPC H02J 3/38
USPC 307/24

(57) ABSTRACT

A power conversion system for an energy storage system includes: at least two conversion units respectively configured to be coupled to one or more power sources or loads; and at least one output controller configured to generate at least one reference voltage to control at least one of the at least two conversion units, wherein the at least one of the at least two conversion units includes: a plurality of conversion subunits having inputs coupled to at least one of the power sources and having outputs that are coupled to one another; and at least one conversion subunit controller configured to adjust output voltages of the plurality of conversion subunits to be substantially the same corresponding to the at least one reference voltage, wherein the at least one reference voltage corresponds to the output voltages and output currents of the plurality of conversion subunits.

### TECHNICAL FIELD

One or more embodiments of the present invention relate to a power conversion system for an energy storage system, and a method of controlling the power conversion system.

### BACKGROUND ART

As the destruction of the environment and the depletion of natural resources are becoming more evident problems, systems for storing energy and efficiently using the stored energy are beginning to draw more attention. Also, interest about renewable energy that does not cause or causes less environmental pollution while generating power has increased. An energy storage system that can interconnect, among other elements, renewable energy, batteries that store power, and an existing power grid, has been developed in step with the changing attitudes regarding today's environment.

The energy storage system can have various storing capacities, according to power consumption of a load. Accordingly, in order to supply a large capacity of power, the energy storage system can be configured to be connected to a plurality of power sources connected in parallel. For example, the energy storage system can be supplied power from a plurality of power generation modules that are connected in parallel and generate power from renewable energy sources. Likewise, the energy storage system can be connected to a plurality of batteries in parallel to be supplied power from the batteries. At this point, the energy storage system transforms the supplied power to a direct current link voltage using a converter. In this case, if the power to be converted is large, a multiple number of converters can be used. Likewise, if the power to be converted is large, a multiple number of inverters that convert the supplied power to an alternating current power for, for example, a power grid can be used by connecting the inverters in parallel.

### DISCLOSURE OF INVENTION

### Technical Problem

One or more embodiments of the present invention include a power conversion system for an energy storage system that reduces generation of a circulating current, and a method of controlling the power conversion system.

### Solution to Problem

According to aspects of an embodiment of the present invention, a power conversion system for an energy storage system includes: at least two conversion units respectively configured to be coupled to one or more power sources or loads; and at least one output controller configured to generate at least one reference voltage to control at least one of the at least two conversion units, wherein the at least one of the at least two conversion units includes: a plurality of conversion subunits having inputs coupled to at least one of the power sources and having outputs that are coupled to one another; and at least one conversion subunit controller configured to adjust output voltages of the plurality of conversion subunits to be substantially the same corresponding to the at least one reference voltage, wherein the at least one reference voltage corresponds to the output voltages and output currents of the plurality of conversion subunits.

The power conversion system may further include a direct current (DC) link unit coupled to the at least two conversion units; and at least one switch coupled to one of the at least two conversion units on a side opposite to the DC link unit.

The at least one output controller may include a power computing unit for computing respective power outputs of the conversion subunits corresponding to the output voltages and the output currents; a power comparing unit for comparing the computed power outputs; and a control signal generation unit for generating the at least one reference voltage corresponding to the comparison of the computed power outputs. The at least one output controller may further include a voltage measuring unit for measuring the output voltages of the plurality of conversion subunits; and a current measuring unit for measuring the output currents of the plurality of conversion subunits.

The at least one of the at least two conversion units may be configured to be coupled to at least one direct current power source from among the power sources, wherein the plurality of conversion subunits includes a plurality of converters configured to perform a DC-DC conversion to convert input voltage levels from the at least one direct current power source to substantially a first voltage level.

The at least one direct current power source may include a power generation system.

The at least one direct current power source may include a battery. At least one of the plurality of converters may further be configured to perform a DC-DC conversion to convert an input having the first voltage level to an output having a second voltage level to be output to the battery.

Each of the converters may include an inductor, a switching device, a diode, and a capacitor, wherein the at least one conversion subunit controller is configured to adjust the output voltage of each of the converters by controlling operation of the switching device of each of the converters corresponding to the at least one reference voltage.

The at least one of the at least two conversion units may be configured to be coupled to one or more loads configured to receive alternating current, wherein the plurality of conversion subunits includes a plurality of inverters configured to convert direct current from the at least one of the power sources to alternating current to be output to the one or more loads.

The direct current from the at least one of the power sources may be configured to be supplied to the at least one of the at least two conversion units through a DC link unit.

The one or more loads may be configured to be operated at a first alternating current power, wherein the at least one conversion subunit controller is configured to control the plurality of inverters to convert direct currents to respective alternating currents, and to adjust at least one of voltage levels, current levels, frequencies, or phases of the respective alternating currents corresponding to the first alternating current power. The at least one conversion subunit controller may be configured to control the plurality of inverters to adjust the alternating current corresponding to the at least one reference voltage and a rectifying voltage. The one or more loads may include a power grid, wherein the at least one of the at least two conversion units further includes a rectifying circuit configured to convert an alternating current from the power grid to a direct current to be output to the at least one of the power sources.

Each of the inverters may include at least four switching devices and a filtering circuit including an inductor and a capacitor, wherein the at least one conversion subunit controller is configured to adjust the alternating current of each of the inverters by controlling operation of at least one of the at least four switching devices of each of the inverters corresponding to the at least one reference voltage.

A power system may include: a plurality of energy storage systems each including a respective power conversion system, wherein the plurality of energy storage systems are configured to be coupled to one or more power generation systems, and to be coupled to at least one of a power grid or another load; and a master controller coupled to the energy storage systems for generating control signals corresponding to output values and/or parameters of each of the energy storage systems; wherein the at least one output controller of each of the energy storage systems is configured to control the output values and/or parameters of the energy storage systems corresponding to the control signals.

The at least one output controller of one of the energy storage systems may include the master controller.

According to aspects of another embodiment of the present invention, a method for controlling a conversion unit of a power conversion system including a plurality of conversion subunits having inputs coupled to one or more power sources and outputs coupled to one another, an output controller, and at least one conversion subunit controller, includes: measuring output voltages and output currents of the plurality of conversion subunits; computing respective power outputs of the plurality of conversion subunits corresponding to the output voltages and the output currents; comparing the computed power outputs; generating at least one reference voltage corresponding to the comparison of the computed power outputs; generating control signals corresponding to the at least one reference voltage; and controlling the plurality of conversion subunits corresponding to the control signals.

The plurality of conversion subunits may include a plurality of converters configured to convert a first direct current from the one or more power sources to a second direct current to be output to a DC link unit.

The plurality of conversion subunits may include a plurality of inverters configured to convert direct current from the one or more power sources to alternating current to be output to one or more loads.

### Advantageous Effects of Invention

According to embodiments of the present invention, a power conversion system for an energy storage system that reduces generation of a circulating current when power is transformed, and a method of controlling the power conversion system, is provided.

### BRIEF DESCRIPTION OF DRAWINGS

These and/or other aspects will become apparent and more readily appreciated from the following description of the embodiments, taken in conjunction with the accompanying drawings, of which:

FIG. 1 is a schematic block diagram illustrating a configuration of an energy storage system according to an embodiment of the present invention;

FIG. 2 is a schematic block diagram illustrating a portion of a configuration of a power conversion system according to an embodiment of the present invention;

FIG. 3a is a circuit diagram illustrating an example of converters and a converter controller of FIG. 2;

FIG. 3b is a schematic block diagram illustrating an example of an output controller of FIG. 2;

FIG. 4 is a flowchart illustrating a method of converting power according to an embodiment of the present invention;

FIG. 5 is a schematic block diagram illustrating a portion of a configuration of a power conversion system according to another embodiment of the present invention;

FIG. 6a is a circuit diagram illustrating an example of inverters and an inverter controller of FIG. 5;

FIG. 6b is a schematic block diagram illustrating an example of an output controller of FIG. 5;

FIG. 7 is a flowchart illustrating a method of inverting power according to another embodiment of the present invention;

FIG. 8 is a schematic block diagram illustrating a configuration of connecting a plurality of energy storage systems according to an embodiment of the present invention; and

FIG. 9 is a schematic block diagram illustrating a configuration of connecting a plurality of energy storage systems according to another embodiment of the present invention.

### BEST MODE FOR CARRYING OUT THE INVENTION

According to aspects of an embodiment of the present invention, a power conversion system for an energy storage system includes: at least two conversion units respectively configured to be coupled to one or more power sources or loads; and at least one output controller configured to generate at least one reference voltage to control at least one of the at least two conversion units, wherein the at least one of the at least two conversion units includes: a plurality of conversion subunits having inputs coupled to at least one of the power sources and having outputs that are coupled to one another; and at least one conversion subunit controller configured to adjust output voltages of the plurality of conversion subunits to be substantially the same corresponding to the at least one reference voltage, wherein the at least one reference voltage corresponds to the output voltages and output currents of the plurality of conversion subunits.

### Mode for the Invention

This application claims the benefit of U.S. Provisional Application No. 61/389,083, filed on Oct. 1, 2010, in the USPTO, the disclosure of which is incorporated herein in its entirety by reference.

While exemplary embodiments of the invention are susceptible to various modifications and alternative forms, specific embodiments thereof are shown by way of example in the drawings and will herein be described in detail. It should be understood, however, that there is no intent to limit embodiments of the invention to the particular forms disclosed, but conversely, exemplary embodiments of the invention are meant to cover all modifications, equivalents, and alternatives falling within the spirit and scope of the invention. In the following description detailed description of known functions and configurations incorporated herein may be omitted when such details may make the subject matter of embodiments of the present invention unclear.

Hereinafter, the present invention will be described in detail by explaining embodiments of the invention, with reference to the attached drawings. Like reference numerals in the drawings denote like elements, and thus repeated descriptions may be omitted.

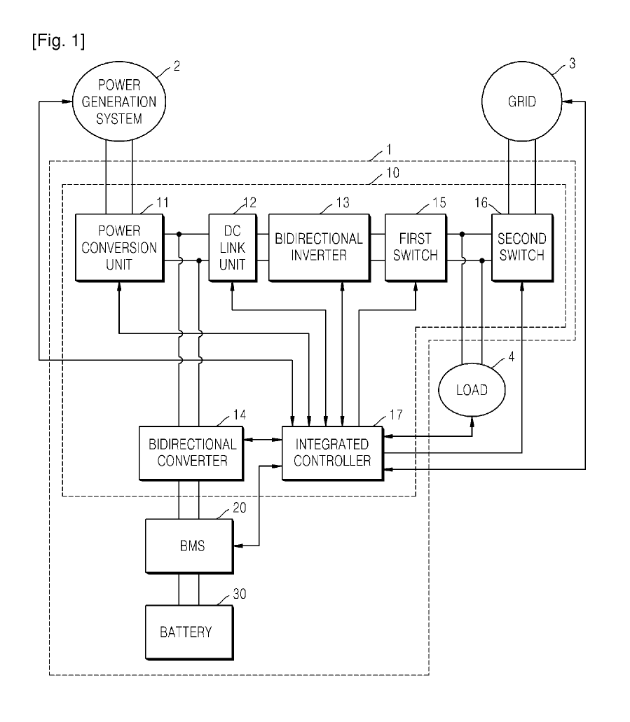

FIG. 1 is a schematic block diagram illustrating a configuration of an energy storage system 1 according to an embodiment of the present invention.

Referring to FIG. 1, the energy storage system 1 according to an embodiment of the present invention supplies power to a load 4 in connection with a power generation system 2 and a grid 3 (e.g., a power grid).

The power generation system 2 generates power using an energy source. The power generation system 2 supplies generated power to the energy storage system 1. The power generation system 2 may be a solar power generation system, a wind power generation system, or a tidal power generation system. However, the power generation system 2 according to embodiments of the present invention is not limited to the power generation systems described above. That is, all power generation systems that generate power using, for example, a renewable energy source such as solar energy or geothermal heat etc. may be utilized. In particular, a solar cell that generates electrical energy using solar energy is easily installed in each house or plant, and thus, it may be suitable for applying the energy storage system 1 in such houses, plants or factories. The power generation system 2 can be configured to be a large capacity energy system by generating power from a plurality of generation modules connected in parallel.

The grid 3 may include power generation plants, substations, and transmission lines. In a normal state, the grid 3 supplies power to the energy storage system 1 so as to be supplied to the load 4 and/or a battery 30, and receives power from the energy storage system 1. When the grid 3 is not in a normal state, the power supply from the grid 3 to the power energy system 1 may be stopped, and also the power supply from the energy storage system 1 to the grid 3 may be stopped.

The load 4 consumes power generated from the power generation system 2, power stored in the battery 30, and/or power supplied from the grid 3. A house or a plant may be an example of the load 4.

The energy storage system 1 may store energy generated from the power generation system 2 in the battery 30, and may supply power to the grid 3. Also, the energy storage system 1 may supply power stored in the battery 30 to the grid 3, or may store power or energy supplied from the grid 3 in the battery 30. Also, the energy storage system 1 may supply power to the load 4 by performing an uninterruptible power supply (UPS) operation when the grid 3 is in an abnormal situation, for example, when a power failure of the grid 3 occurs. Also, even when the grid 3 is in a normal state, the energy storage system 1 may supply power generated from the power generation system 2 or power stored in the battery 30 to the load 4.

The energy storage system 1 includes a power conversion system (PCS) 10 that controls power conversion, a battery management system (BMS) 20, and the battery 30.

The PCS 10 supplies power from the power generation system 2, the grid 3 and the battery 30 to places where desired or necessary, by converting supplied power to an appropriate level. The PCS 10 may include a power conversion unit 11, a DC link unit 12, a bidirectional inverter 13, a bidirectional converter 14, a first switch 15, a second switch 16, and an integrated controller 17.

The power conversion unit 11 is connected between the power generation system 2 and the DC link unit 12. The power conversion unit 11 transmits power generated from the power generation system 2 to the DC link unit 12, and converts an output voltage to a direct current link voltage.

The power conversion unit 11 may be configured to be or include a power conversion circuit such as a converter or a rectifying circuit, according to the type of the power generation system 2. When a power that the power generation system 2 generates is a direct current, the power conversion unit 11 may include a converter that transforms direct current to direct current. When a power that the power generation system 2 generates is an alternating current, the power conversion unit 11 may include a rectifying circuit that transforms the alternating current to a direct current. In addition, when the power generation system 2 generates power using solar energy, the power conversion unit 11 may include a maximum power point tracking (MPPT) converter that performs a maximum power point tracking control, so that the power generation system 2 can generate maximum or increased power according to the changes of solar radiation or temperature. When the power generation system 2 does not generate power, the power conversion unit 11 can minimize or reduce consumption of power by stopping operation of the converter or other associated elements.

When a plurality of generation modules included in the power generation system 2 are connected in parallel, all of the plurality of generation modules can be connected to a single power conversion circuit. When an amount of power generated from the generation modules is large, the power conversion unit 11 may include a plurality of power conversion circuits or subunits, so that the transformation of the power generated from the generation modules can be performed by dividing the power between the conversion circuits or subunits. For example, if the power generation system 2 is a solar power generation system, the power generation system 2 may include a plurality of solar cells, and each of the solar cells may be connected to any MPPT converter from among a plurality of MPPT converters connected in parallel.

In some instances, a magnitude of a direct current (DC) link voltage may be unstable due to a voltage-sag in the power generation system 2 or the grid 3, or due to a peak load generated in the load 4. However, the direct current link voltage should be stable for normal operations of the bidirectional inverter 13 and the bidirectional converter 14. A DC link unit 12 may include, for example, a large capacitor for the stabilization of the DC link voltage. Such a DC link unit 12 may be connected between the power conversion unit 11 and the bidirectional inverter 13, to maintains the DC link voltage.

The bidirectional inverter 13 is a power conversion device that may be connected between the DC link unit 12 and a first switch 15. In a discharging mode, the bidirectional inverter 13 may include an inverter that outputs an alternating current voltage to the grid 3 by converting a DC link voltage outputted from the power generation system 2 and/or the battery 30. Also, in a charging mode, the bidirectional inverter 13 may include a rectifying circuit that outputs a DC link voltage by rectifying an alternating current voltage from the grid 3 to store power from the grid 3 in the battery 30.

The bidirectional inverter 13 may include a filter for removing harmonics from an alternating current voltage outputted to the grid 3. Also, the bidirectional inverter 13 may include a phase locked loop (PLL) circuit for synchronizing a phase of an alternating current voltage outputted from the bidirectional inverter 13 to a phase of an alternating current voltage of the grid 3, to suppress the generation of reactive power. Also, the bidirectional inverter 13 may perform functions such as voltage variation range limitation, power-factor improvement, direct current component removal, and transient phenomena protection. The operation of the bidirectional inverter 13 may be stopped when it is unnecessary to operate it, to minimize or reduce power consumption.

When an amount of power supplied from the power generation system 2 or the battery 30 is large, the bidirectional inverter 13 may include a plurality of inverters, so that the transformation of the supplied power to the power for the grid 3 can be performed by dividing the power between the inverters. For example, when the power conversion unit 11 includes a plurality of power conversion circuits or subunits, each of the power conversion circuits may be connected to a plurality of inverters connected in parallel.

The bidirectional converter 14 is a power conversion device that may be connected between the DC link unit 12 and the battery 30. In a discharge mode, the bidirectional converter 14 includes a converter that outputs the power stored in the battery 30 at a voltage level that can be utilized by the bidirectional inverter 13, for example, the DC link voltage, by a DC-DC conversion. In a charging mode, the bidirectional converter 14 includes a converter that outputs the power outputted from the power conversion unit 11 or the bidirectional inverter 13 at a voltage level that can be utilized by the battery 30, for example, a charging voltage, by a DC-DC conversion. The operation of the bidirectional converter 14 may be stopped when charging and discharging of the battery 30 is not performed, to minimize or reduce power consumption.

When the battery 30 includes a plurality of battery racks, the battery racks can be connected to one bidirectional converter 14. Also, when the capacity of the battery racks is large, the bidirectional converter 14 may include a plurality of converters so that the transformation of the power outputted from the battery racks can be performed by dividing the power between the converters. Here, the battery rack is an element of lower layer configuring the battery 30.

The first switch 15 and the second switch 16 may be connected between the bidirectional inverter 13 and the grid 3, and may control a current flow between the power generation system 2 and the grid 3 by performing ON/OFF operations in response to control by the integrated controller 17. ON/OFF operations of the first switch 15 and the second switch 16 may be determined according to the states of the power generation system 2, the grid 3, and the battery 30. For example, when the magnitude of power required by the load 4 is large, both the first switch 15 and the second switch 16 may be turned to an ON-state, so that power in the power generation system 2 and the grid 3 can be used. If the power generated from the power generation system 2 and the power from the grid 3 cannot meet the power requirements of the load 4, the power stored in the battery 30 may further be supplied to the load 4. However, when there is a power failure in the grid 3, the second switch 16 may be turned to an OFF-state, while the first switch 15 is turned to an ON-state. In this way, power from the power generation system 2 or the battery 30 can be supplied to the load 4, and flow of power from the PCS 10 to the grid 3 may be prevented. Therefore, an accident such as an electric shock of a worker by power lines of the grid 3 can be prevented.

The integrated controller 17 may monitor the states of the power generation system 2, the grid 3, the battery 30, and the load 4, and may control the power conversion unit 11, the bidirectional inverter 13, the bidirectional converter 14, the first switch 15, the second switch 16, and the BMS 20 in response to the monitoring results. The integrated controller 17 may include monitoring of whether there is a power failure in the grid 3, and/or whether power is generated from the power generation system 2. Also, the integrated controller 17 may monitor the amount of power generated from the power generation system 2, the charge state of the battery 30, the power consumption of the load 4, and time, among other parameters. Accordingly, the integrated controller may include or be made up of one or more output controllers associated with the power conversion unit 11, the bidirectional inverter 13, and/or the bidirectional converter 14, discussed in more detail below.

The BMS 20 is connected to the battery 30, and controls charge and discharge of the battery 30 in response to the control of the integrated controller 17. The BMS 20 may perform, for example, an overcharge protection function, an overdischarge protection function, an overcurrent protection function, an overvoltage protection function, an overheating protection function, and/or a cell balancing function, to protect the battery 30. Accordingly, the BMS 20 may monitor voltage, current, temperature, remaining power, lifetime, and charge state of the battery 30, and apply the monitoring results to the integrated controller 17.

The battery 30 stores power generated from the power generation system 2 or supplied from the grid 3, and supplies power to the load 4 or the grid 3.

The battery 30 may include at least one battery rack connected in series and/or in parallel, and each battery rack may include at least one battery tray connected in series and/or in parallel. Each of the battery trays may further include a plurality of battery cells. The battery 30 may include various kinds of battery cells, for example, a nickel-cadmium battery, a lead (Pb) storage battery, a nickel metal hydride (NIMH) battery, a lithium ion battery, and/or a lithium polymer battery. The number of battery racks of the battery 30 may be determined according to the power capacity and design conditions desired for the energy storage system 1. For example, if the power consumption of the load 4 is large, the battery 30 may be configured to include a plurality of battery racks, and if the power consumption of the load 4 is small, the battery 30 may be configured to include a single battery rack.

According to the current embodiment, the energy storage system 1 may include a plurality of power conversion circuits, a plurality of converters, and/or a plurality of inverters according to the capacity of the energy storage system 1. However, when converters or inverters are connected in parallel, various parameters, for example, the magnitude or phase of an output voltage or an output current at the converters or inverters output stages may be different according to the switching operations of switching devices included in each of the converters or inverters. Here, the parameters may be elements representing, for example, characteristics of power output from the converters or inverters, but parameters according to embodiments of the present invention are not limited to the parameters described above. Due to the parameter differences at the converters or inverters output stages, a circulating current may be generated between the converters or inverters. As such, circulating current may be generated in the power conversion circuits. Accordingly, it is important to prevent or reduce generation of a circulating current in the energy storage system 1. Thus, a method of preventing or reducing the generation of a circulating current in the energy storage system 1 according to embodiments of the present invention will now be described.

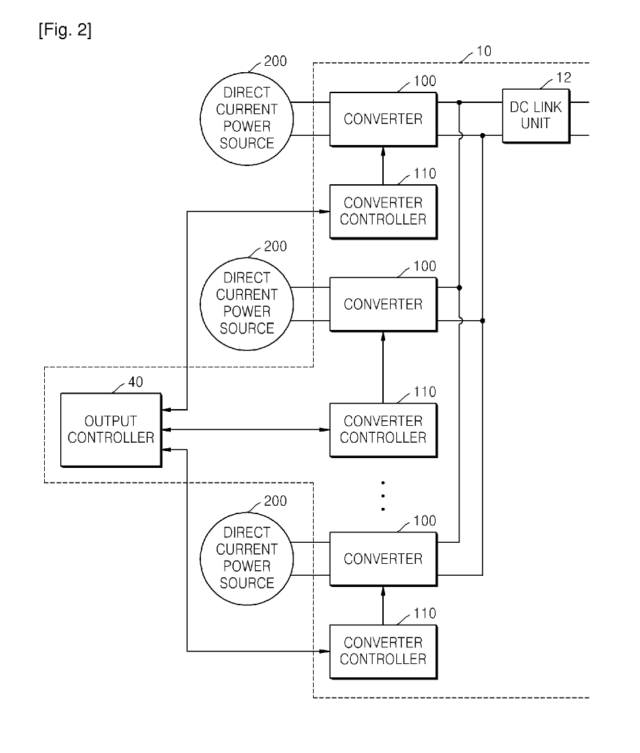

FIG. 2 is a schematic block diagram illustrating a portion of a configuration of a PCS 10 according to an embodiment of the present invention.

Referring to FIG. 2, the PCS 10 includes a plurality of conversion subunits, such as converters 100, connected in parallel. The converters 100 receive power form a direct current power source 200. The converters 100 output power by transforming a voltage of the received power corresponding to a reference voltage, which may be a preset voltage. Output stages of the converters 100 are commonly connected, and power output to the output stages of the converters 100 may be supplied to the DC link unit 12. Here, the direct current power source 200 may be the power output from the power generation system 2 or the battery 30.

Each of the converters 100 may further include or be associated with a conversion subunit controller, such as a converter controller 110, that controls the transformation of supplied power. The converter controller 110 controls the voltage of outputted power to be substantially the same as a reference voltage by, for example, controlling a duty ratio of a switching device included in the converter 100. Here, each of the converters 100 may be included in one of the power conversion units 11 or the bidirectional converters 14.

An output controller 40 controls the converter controllers 110 so that the converter controllers 110 can control each of the converters 100, respectively, so as to prevent or reduce generation of a circulating current between the converters 100. The output controller 40 measures or receives various data, for example, signals representing output voltages and/or output currents of the converters 100, and computes power output of the converters 100 using the output voltages and the output currents measured or received. The output controller 40 may apply an appropriate control signal, for example, a reference voltage, to each of the converter controllers 110 based on the computed power output. The control signal may be a signal that reduces the differences between power outputs of the converters 100.

In the current embodiment, it is depicted that each of the converter controllers 110 controls a single converter 100. However, this is an example, and embodiments of the present invention are not limited thereto. For example, a conversion unit can be configured such that a plurality of converter controllers 110 is combined into a single IC to control the converters 100. In addition, the output controller 40 may be included, for example, in the conversion unit, or may alternatively be included in the integrated controller 17 as described in FIG. 1.

A method of preventing generation of a circulating current by controlling the converters 100 of FIG. 2 will now be described in more detail.

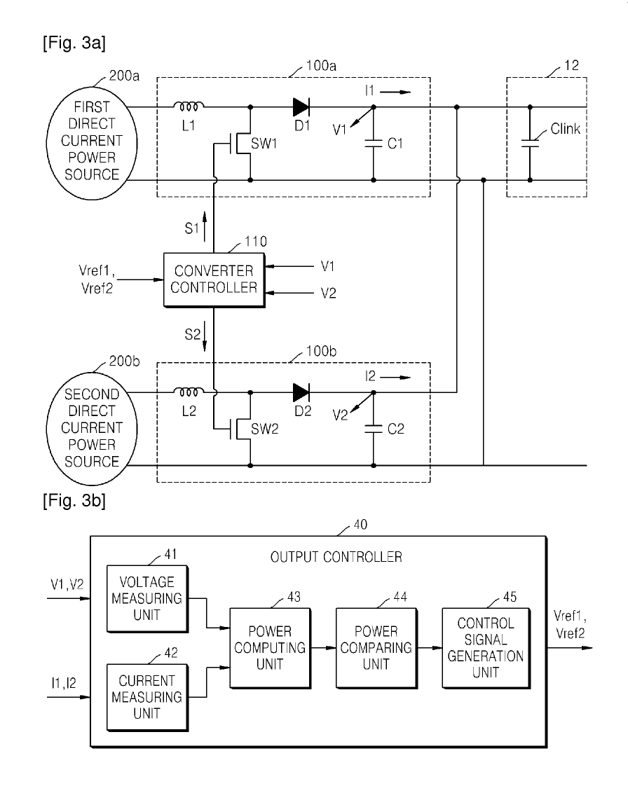

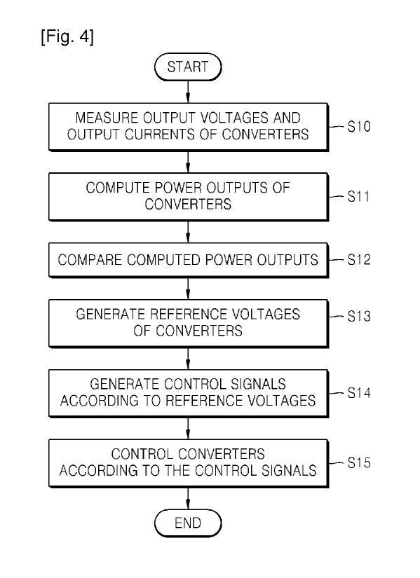

FIG. 3a is a circuit diagram illustrating an example of converters 100 and a converter controller 110 of FIG. 2, and FIG. 3b is a schematic block diagram illustrating an example of an output controller 40 of FIG. 2. FIG. 4 is a flowchart illustrating a method of converting power according to an embodiment of the present invention.

Referring to FIGS. 3a and 3b, the PCS 10 may include a first converter 100a, a second converter 100b, the converter controller 110, and the output controller 40.

The first converter 100a may be a booster converter that includes a first inductor L1, a first switching device SW1, a first diode D1, and a first capacitor C1. The second converter 100b may also be a booster converter that includes a second inductor L2, a second switching device SW2, a second diode D2, and a second capacitor C2. However, the configuration of the converters 100 is an example, and should not be limited thereto. The converters 100 may have various configurations.

The first converter 100a and the second converter 100b respectively receive direct current power from a first direct current power source 200a and a second direct current power source 200b. The first converter 100a and the second converter 100b are connected in parallel, and output stages of the first converter 100a and the second converter 100b may be connected to the DC link unit 12. The first converter 100a and the second converter 100b may be converters included in, for example, the power conversion unit 11 and/or the bidirectional converter 14. A ratio of voltage increase or decrease of the first converter 100a and the second converter 100b is controlled according to the switching operation of the first switching device SW1 and the second switching device SW2, and as a result, the magnitude of output voltage can be determined or adjusted.

The converter controller 110 generates a first switching signal S1 and a second switching signal S2, and controls the ratio of voltage increase or decrease of the first converter 100a and/or the second converter 100b by controlling operation of the first switching device SW1 and the second switching device SW2, respectively included in the first converter 100a and the second converter 100b, using the first switching signal S1 and the second switching signal S2. A first output voltage V1 which is an output voltage from the first converter 100a and a second output voltage V2 which is an output voltage from the second converter 100b may be applied to the converter controller 110. Also a signal representing a first reference voltage Vref 1 and a second reference voltage Vref2 may be applied to the converter controller 110 from the output controller 40.

The output controller 40 computes power outputs of the first converter 100a and the second converter 100b, and generates signals to control the first converter 100a and the second converter 100b by comparing the computed power outputs. Referring, for example, to FIG. 3b, the output controller 40 may include a voltage measuring unit 41, a current measuring unit 42, a power computing unit 43, a power comparing unit 44, and a control signal generation unit 45.

The voltage measuring unit 41 and the current measuring unit 42 respectively measure the first output voltage V1 and the second output voltage V2 from the first converter 100a and the second converter 100b and a first output current I1 and a second output current I2 from the first converter 100a and the second converter 100b. The voltage measuring unit 41 and the current measuring unit 42 may directly measure the output voltages and the output currents. Alternatively, for example, the output controller 40 may be configured such that the first and second output voltages V1 and V2 and the first and second output currents I1 and I2 may be measured by an additional apparatus outside of the converter controller 110 or the output controller 40, and the measured first and second output voltages V1 and V2 and the first and second output currents I1 and I2 may then be respectively applied to the output controller 40. The voltage measuring unit 41 and the current measuring unit 42 apply the measured or applied first and second output voltages V1 and V2 and the first and second output currents I1 and I2 to the power computing unit 43.

The power computing unit 43 computes power output using the output voltages V1 and V2 and the output currents I1 and I2 from the voltage measuring unit 41 and the current measuring unit 42.

The power comparing unit 44 receives the value of the power outputs of the first converter 100a and the second converter 100b from the power computing unit 43, and compares the received power outputs.

The control signal generation unit 45 receives the comparison results of the power outputs from the power comparing unit 44, and generates control signals for controlling the converter controller 110 according to the comparison results. The control signals may be signals representing the first reference voltage Vref1 and the second reference voltage Vref2, which are respectively used for controlling the first converter 100a and the second converter 100b by the converter controller 110.

As indicated above, the output controller 40 according to the current embodiment of the present invention may be included in the integrated controller 17 as described with respect to FIG. 1, or may be an additional apparatus separated from the integrated controller 17 in FIG. 1.

A parasitic impedance component such as parasitic conductance or parasitic capacitance may exist in a wire between the output stages of the first and second converters 100a and 100b. Accordingly, although the first and second output voltages V1 and V2 are illustrated as being measured in the same node in FIG. 3a, this is only for convenience of explanation. In other words, the first and second output voltages V1 and V2 may have different values and may be measured separately using various different methods.

Hereinafter, a method of controlling the converter controller 110 and the output controller 40 in the PCS 10 will now be described.

Referring to FIG. 4, the output controller 40 measures the output voltages and the output currents of the first converter 100a and the second converter 100b (Step 10).

When the output voltages and the output currents of the first converter 100a and the second converter 100b are respectively measured, the output controller 40 computes power outputs of the first converter 100a and the second converter 100b by multiplying the measured output voltages with the measured output currents (Step 11).

When the power outputs of the first converter 100a and the second converter 100b are respectively computed, the output controller 40 compares the computed power outputs (Step 12).

According to the comparison result of the power outputs, the output controller 40 generates control signals that substantially synchronize power outputs of the converters (Step 13). Reference voltages Vref1 and Vref2 for controlling waveforms of the control signals S1 and S2 generated from the converter controller 110 may be used as the control signals. For example, when the power output of the first converter 100a is greater than that of the second converter 100b as a result of the comparison, the magnitude of the first reference voltage Verf1 can be reduced to reduce the power output of the first converter 100a. Alternatively, the magnitude of the second reference voltage Verf2 can be increased to increase the power output of the second converter 100b.

The generated signals representing the reference voltages Verf1 and Verf2 are applied to the converter controller 110, and the converter controller 110 generates control signals 51 and S2 for respectively controlling the first switching device SW1 and the second switching device SW2 according to the applied reference voltages Verf1 and Verf2 and the measured output voltages V1 and V2 (Step 14). Here, the control signals S1 and S2 may be pulse width modulation signals for controlling duty ratios of the first switching device SW1 and the second switching device SW2.

The converter controller 110 controls the operations of the first converter 100a and the second converter 100b by applying the generated signals S1 and S2 to the first switching device SW1 and the second switching device SW2, respectively (Step 15).

As described above, in the PCS 10 according to an embodiment of the present invention, generation of a circulating current between a plurality of converters connected in parallel can be reduced by controlling each of the converters to have substantially the same power outputs.

In the current embodiment, the method of preventing or reducing generation of a circulating current is described in two converters 100a and 100b. However, the present invention is not limited thereto, that is, the present invention can also be applied to cases in which more than two converters are connected in parallel.

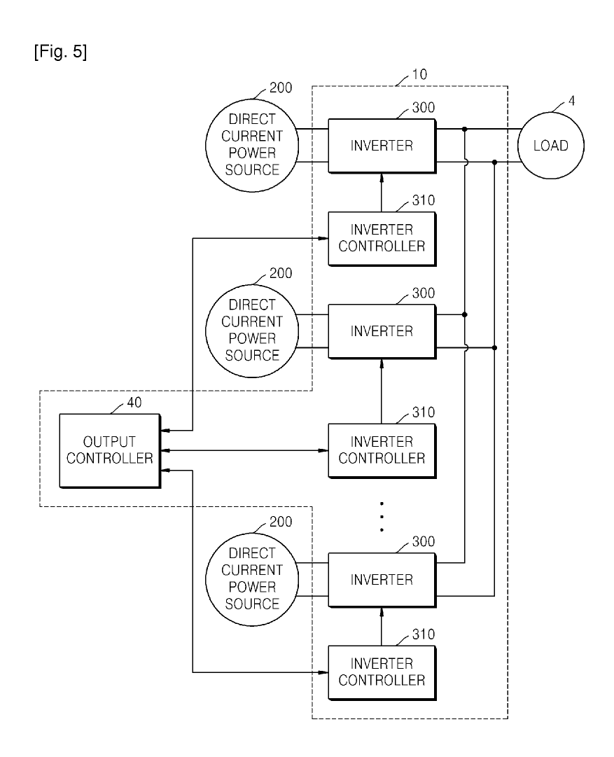

FIG. 5 is a schematic block diagram illustrating a portion of a configuration of a power conversion system (PCS) 10 according to another embodiment of the present invention.

Referring to FIG. 5, the PCS 10 includes a plurality of conversion subunits, such as inverters 300, connected in parallel. The inverters 300 receive power from the direct current power source 200. The inverters 300 output power after transforming a direct current power to an alternating current power, so that the supplied power can have, for example, preset values of voltage, current, phase, and/or frequency. Output stages of the inverters 300 are commonly connected, and the alternating current power outputted to the output stages may be supplied to the grid 3 or the load 4. Here, the direct current power source 200 may be a power outputted from the power generation system 2 or the battery 30 or a transformed power therefrom.

Each of the inverters 300 may further include or be associated with a conversion subunit controller, such as an inverter controller 310, that controls the transformation of supplied power. The inverter controller 310 controls an outputted power to be substantially the same alternating current power as that of, for example, the grid 3, for example, by controlling ON/OFF operations of switching devices included in the inverters 300.

The output controller 40 controls the inverter controllers 310 so that the inverter controllers 310 can control each of the inverters 300, so as to prevent or reduce generation of a circulating current between the inverters 300. The output controller 40 measures or receives various data, for example, an output voltage and/or an output current of the inverters 300, or phases or frequencies of the outputted alternating currents, or computes power output of the inverters 300 using the output voltages and the output currents measured or received. The output controller 40 may apply an appropriate control signal, for example, a signal representing a reference voltage, to each of the inverter controllers 310 based on the computed power output. The control signal may be a signal that reduces the differences between power outputs from the inverters 300.

In the current embodiment, it is depicted that each of the inverter controllers 310 controls a single inverter 300. However, this is an example, and embodiments of the present invention are not limited thereto. For example a conversion unit can be configured such that a plurality of inverter controllers 310 is combined into a single IC to control the inverters 100. In addition, similarly as discussed in previous embodiments, the outputs controller 40 may, for example, be included in the conversion unit, or may alternatively be included in the integrated controller 17 as described in FIG. 1.

A method of preventing generation of a circulating current by controlling the inverters 300 of FIG. 5 will now be described in more detail.

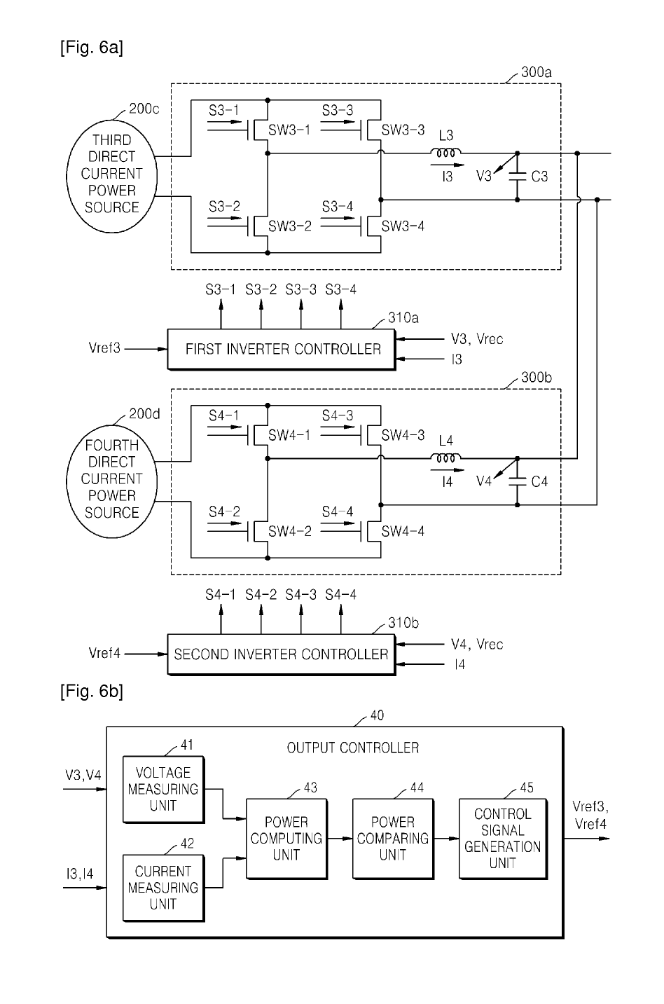

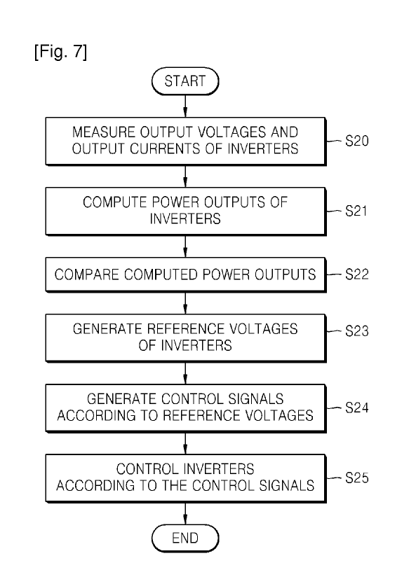

FIG. 6a is a circuit diagram illustrating an example of inverters 300 and an inverter controller 310 of FIG. 5, and FIG. 6b is a schematic block diagram illustrating an example of an output controller 40 of FIG. 5. FIG. 7 is a flowchart illustrating a method of inverting power according to another embodiment of the present invention.

Referring to FIGS. 6a and 6b, the PCS 10 may include a first inverter 300a, a second inverter 300b, a first inverter controller 310a, a second inverter controller 310b, and an output controller 40.

The first inverter 300a may be a full bridge inverter that includes a plurality of switching devices SW3-1 through SW3-4, and may further include a filtering circuit that includes a third inductor L3 and a third capacitor C3. The second inverter 300b may also be a full bridge inverter that includes a plurality of switching devices SW41-through SW4-4, and may further include a filtering circuit that includes a fourth inductor L4 and a fourth capacitor C4. However, the configuration of the inverters 300 is an example, and should not be limited thereto. The inverters 300 may have various configurations. For example, half bridge inverters, pulse width modulation (PWM) inverters, or the like may be used for the inverters 300.

The first inverter 300a and the second inverter 300b respectively receive direct current power from a third direct current power source 200c and a fourth direct current power source 200d. The third direct current power source 200c and the fourth direct current power source 200d may be, for example, the power generation system 2 or the battery 30. The first inverter 300a and the second inverter 300b are connected in parallel, and output stages of the first inverter 300a and the second inverter 300b may be connected to the grid 3 or the load 4. The first inverter 300a and the second inverter 300b may be inverters included in the bidirectional converter 14.

Output voltages, output currents, phases, and/or frequencies of power outputs of the first inverter 300a and the second inverter 300b may be controlled according to switching operations of the switching devices SW3-1 through SW3-4 and SW4-1 through SW4-4.

The first inverter controller 310a may generate control signals S3-1 through S3-4 for controlling ON/OFF operations of the switching devices SW3-1 through SW3-4. A third output voltage V3 which is a voltage output from the first inverter 300a and a third current 13 which is a current output from the first inverter 300a may be applied to the first inverter controller 310a. Also, a rectifying voltage Vrec obtained by rectifying a power of grid 3 and/or a signal representing a third reference voltage Vref3 transmitted from the output controller 40 may be applied to the first inverter controller 310a.

The first inverter controller 310a may include a voltage controller and/or a current controller.

The voltage controller may generate a current command signal that synchronizes the third output voltage V3 to the third reference voltage Vref3. The voltage controller may also generate a current command signal by performing a proportional-integral control which uses a value difference between the third output voltage V3 and the third reference voltage Vref3.

The current controller may generate control signals S3-1 through S3-4 that synchronize the third output current 13 to a current reference signal. The current controller may generate a control signal by performing a proportional-integral control which uses a value difference between the third output current 13 and the current reference signal. At this point, the current reference signal may be generated by multiplying the current command signal with the rectifying voltage Vrec.

The second inverter controller 310b, like the first inverter controller 310a, may generate signals S4-1 through S4-4 for controlling ON/OFF operations of the switching devices SW4-1 through SW4-4. A fourth output voltage V4 which is a voltage output from the second inverter 300b, a fourth output current 14 which is a current output from the second inverter 300b, a rectifying voltage Vrec, and/or a signal representing a fourth reference voltage Vref4 transmitted from the output controller 40 may be applied to the second inverter controller 310b.

The second inverter 300b, like the first inverter 300a, may also include a voltage controller and/or a current controller. Description for the operations of the voltage controller and/or current controller of the second inverter 300b will not be repeated.

The output controller 40 computes power outputs of the first inverter 300a and the second inverter 300b, and generates signals for controlling the first inverter 300a and the second inverter 300b by comparing the computed power outputs. Referring, for example, to FIG. 6b, the output controller 40 may include a voltage measuring unit 41, a current measuring unit 42, a power computing unit 43, a power comparing unit 44, and a control signal generation unit 45.

The voltage measuring unit 41 and the current measuring unit 42 respectively measure the third output voltage V3 and the fourth output voltage V4 from the first inverter 300a and the second inverter 300b, and a third output current 13 and a fourth output current 14 from the first inverter 300a and the second inverter 300b. The voltage measuring unit 41 and the current measuring unit 42 may directly measure the magnitudes and phases of output voltages and output currents. Alternatively, for example, the output controller 40 may be configured such that the third and fourth output voltages V3 and V4 and the third and fourth output currents 13 and 14 are measured by an additional apparatus outside of the inverter controller 310 or the output controller 40, and the measured third and fourth output voltages V3 and V4 and the third and fourth output currents 13 and 14 may then be respectively applied to the output controller 40. The voltage measuring unit 41 and the current measuring unit 42 apply the measured or applied third and fourth output voltages V3 and V4 and the third and fourth output currents 13 and 14 to the power computing unit 43.

The power computing unit 43 computes power output using the third and fourth output voltages V3 and V4 and the third and fourth output currents 13 and 14 from the voltage measuring unit 41 and the current measuring unit 42.

The power comparing unit 44 receives the values of the power outputs of the first inverter 300a and the second inverter 300b from the power computing unit 43, and compares the received power outputs.

The control signal generation unit 45 receives the comparison results of the power outputs from the power comparing unit 44, and generates control signals for controlling the first inverter controller 310a and the second inverter controller 310b according to the comparison results. The control signals may be signals representing the third and fourth reference voltages Vref3 and Vref4, which are respectively used for controlling the first inverter 300a and the second inverter 300b by the first inverter controller 310a and the second inverter controller 310b.

And as indicated above, the output controller 40 according to the current embodiment of the present invention may be included in the integrated controller 17 as described with respect to FIG. 1, or may be an additional apparatus separated from the integrated controller 17 in FIG. 1.

A parasitic impedance component such as parasitic conductance or parasitic capacitance may exist in a wire between the output stages of the first and second inverters 300a and 300b. Accordingly, although the third and fourth output voltages V3 and V4 are illustrated as being measured in the same node in FIG. 6a, this is only for convenience of explanation. In other words, the third and fourth output voltages V3 and V4 may have different values and may be measured separately using various different methods.

Hereinafter, a method of controlling the first inverter controller 310a and the second inverter controller 310b and the output controller 40 in the PCS 10 will now be described.

Referring to FIG. 7, the output controller 40 measures the output voltages and the output currents of the first inverter 300a and the second inverter 300b (Step 20).

When the output voltages and the output currents of the first inverter 300a and the second inverter 300b are respectively measured, the output controller 40 computes power outputs of the first inverter 300a and the second inverter 300b by multiplying the measured output voltages with the measured output currents (Step 21).

When the power outputs of the first inverter 300a and the second inverter 300b are respectively computed, the output controller 40 compares the computed power outputs (Step 22).

According to the comparison result of the power outputs, the output controller 40 generates control signals that substantially synchronize power outputs of inverters (Step 23). Third and fourth reference voltages Vref3 and Vref4 for controlling waveforms of the control signals S3-1 through S3-4 and S4-1 through S4-4 generated from the first inverter controller 310a and the second inverter controller 310b may be used as the control signals. For example, when the power output of the first inverter 300a is greater than that of the second inverter 300b as a result of the comparison, the magnitude of the third reference voltage Vref3 can be reduced to reduce the power output of the first inverter 300a. Alternatively, the magnitude of the fourth reference voltage Vref4 can be increased to increase the power output of the second inverter 300b.

The generated third and fourth reference voltages Vref3 and Vref4 are respectively applied to the first inverter controller 310a and the second inverter controller 310b, and the first inverter controller 310a and the second inverter controller 310b may generate control signals S3-1 through S3-4 and S4-1 through S4-4 for respectively controlling the switching device SW3-1 through SW3-4 and SW4-1 through SW4-4 according to the applied third and fourth reference voltages Vref3 and Vref4, the measured third and fourth output voltages V3 and V4, and/or the third and fourth output currents 13 and 14 (Step 24). Here, the control signals S3-1 through S3-4 and S4-1 through S4-4 may be pulse width modulation signals for controlling duty ratios of the switching devices SW3-1 through SW3-4 and SW4-1 through SW4-4.

The first inverter controller 310a and the second inverter controller 310b control the operations of the first inverter 300a and the second inverter 300b by applying the generated control signals S3-1 through S3-4 and S4-1 through S4-4 to the switching devices SW3-1 through SW3-4 and SW4-1 through SW4-4, respectively (Step 25).

As described above, in the PCS 10 according to another embodiment of the present invention, generation of a circulating current between a plurality of inverters connected in parallel can be reduced by controlling each of the inverters to have substantially the same power outputs. In the current embodiment, the magnitude of power outputs is compared. However, this is an example, and thus, it will be understood by those skilled in the art that various configurations may be made to synchronize power outputs by comparing various parameters other than the magnitudes of the power outputs, such as phase or frequency.

In the current embodiment, the method of preventing or reducing generation of a circulating current is described in the two inverters 300a and 300b. However, the present invention is not limited thereto, that is, the present invention can also be applied to cases in which more than two inverters are connected in parallel.

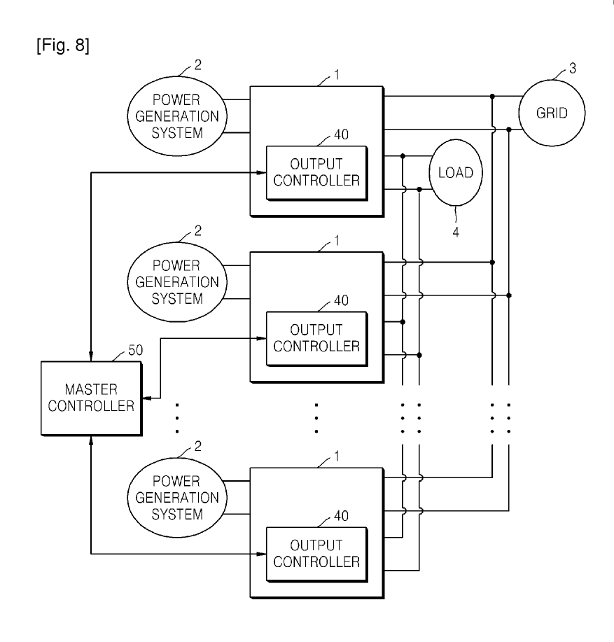

FIG. 8 is a schematic block diagram illustrating a configuration of connecting a plurality of energy storage systems 1 according to an embodiment of the present invention. FIG. 8 shows a case in which a plurality of energy storage systems 1 is connected to a single load 4 as, for example, an extended case of the embodiments of FIGS. 5 through 7.

In the case of the current embodiment, each of the energy storage systems 1 may include bidirectional inverters 13 for supplying power to a load 4. Accordingly, the bidirectional inverters 13 included in each of the power storage systems 1 may be connected in parallel with respect to the load 4, and a circulating current may be generated between the energy storage systems 1 due to a difference in parameters between power outputted from each of the energy storage systems 1 to the load 4. However, in the current embodiment, the generation of a circulating current between the energy storage systems 1 may be prevented or reduced.

Referring to FIG. 8, a configuration for showing a method of power transformation according to the current embodiment may include a load 4, a plurality of energy storage systems 1 connected in parallel, and a master controller 50.

Each of the energy storage systems 1 may be individually or commonly connected to a power generation system 2. Also, each of the energy storage systems 1 may receive power from a grid 3.

Each of the energy storage systems 1 may measure values of various parameters of the power outputs of the bidirectional inverters 13 through output controllers 40, and may apply the measured values of the parameters to the master controller 50.

The master controller 50 controls the output controllers 40 included in each of the energy storage systems 1 to control the energy storage systems 1 to not generate or to reduce occurrence of a circulating current. The master controller 50 computes each of the power outputs using various parameters of the power outputs received from the output controllers 40. The master controller 50 may apply appropriate control signals to the output controllers 40 based on the computed power outputs.

The method of computing power in the master controller 50 and controlling the output controllers 40, and also the method of substantially synchronizing power outputs by controlling the bidirectional inverters 13 corresponding to the output controllers 40 may be substantially the same as the descriptions above in reference to FIGS. 5 through 7, and thus, a similar description will not be repeated.

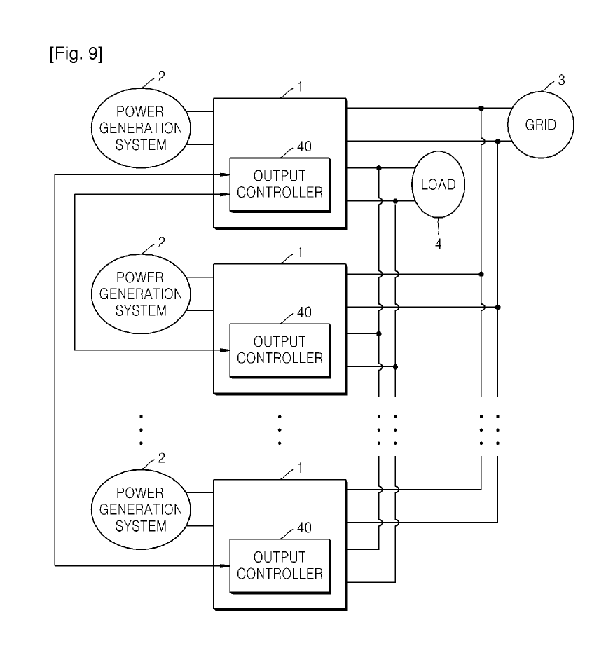

FIG. 9 is a schematic block diagram illustrating a configuration of connecting a plurality of energy storage systems 1 according to another embodiment of the present invention.

Referring to FIG. 9, in the current embodiment, functionality of the master controller 50 of FIG. 8 may be included in one of the output controllers 40 of one of the energy storage systems 1. Accordingly, each of the output controllers 40 may measure values of various parameters of corresponding power outputs, and may apply the measured values of the parameters to the output controller 40 that performs the functions of the master controller 50. The output controller 40 that performs the functions of the master controller 50 may compute each of the power outputs based on the received values, and may generate control signals for controlling each of the output controllers 40. The operation of the output controllers 40 according to the current embodiment is substantially the same as that of the master controller 50 and the output controllers 40 of FIG. 8, and thus, descriptions thereof will not be repeated.

As described above, when a plurality of energy storage systems 1 is connected to a load 4 in parallel, power outputs outputted from each of the energy storage systems 1 may be controlled to be substantially synchronized by a master controller 50 or by an output controller 40 that performs the functions of such a master controller 50. Therefore, generation of a circulating current between energy storage systems 1 may be reduced.

It should be understood that the exemplary embodiments described herein should be considered in a descriptive sense only, and not for purposes of limitation. Descriptions of features or aspects within each embodiment should be considered as available for other similar features or aspects in other embodiments. It should also be understood that the invention is intended to cover various modifications and equivalent arrangements included within the spirit and scope of the appended claims, and equivalents thereof.

1. A power conversion system for an energy storage system, the power conversion system comprising:
at least two conversion units respectively configured to be coupled to one or more power sources or loads; and
at least one output controller configured to generate at least one reference voltage to control at least one of the at least two conversion units,
wherein the at least one of the at least two conversion units comprises:
a plurality of conversion subunits having inputs coupled to at least one of the power sources and having outputs that are coupled to one another; and
at least one conversion subunit controller configured to adjust output voltages of the plurality of conversion subunits to be substantially the same corresponding to the at least one reference voltage,
wherein the at least one reference voltage corresponds to the output voltages and output currents of the plurality of conversion subunits.

2. The power conversion system of claim 1, further comprising:
a direct current (DC) link unit coupled to the at least two conversion units; and
at least one switch coupled to one of the at least two conversion units on a side opposite to the DC link unit.

3. The power conversion system of claim 1, wherein the at least one output controller comprises:
a power computing unit for computing respective power outputs of the conversion subunits corresponding to the output voltages and the output currents;
a power comparing unit for comparing the computed power outputs; and
a control signal generation unit for generating the at least one reference voltage corresponding to the comparison of the computed power outputs.

4. The power conversion system of claim 3, wherein the at least one output controller further comprises:
a voltage measuring unit for measuring the output voltages of the plurality of conversion subunits; and
a current measuring unit for measuring the output currents of the plurality of conversion subunits.

5. The power conversion system of claim 1, wherein the at least one of the at least two conversion units is configured to be coupled to at least one direct current power source from among the power sources, and wherein the plurality of conversion subunits comprises a plurality of converters configured to perform a DC-DC conversion to convert input voltage levels from the at least one direct current power source to substantially a first voltage level.

6. The power conversion system of claim 5, wherein the at least one direct current power source comprises a power generation system.

7. The power conversion system of claim 5, wherein the at least one direct current power source comprises a battery.

8. The power conversion system of claim 7, wherein at least one of the plurality of converters is further configured to perform a DC-DC conversion to convert an input having the first voltage level to an output having a second voltage level to be output to the battery.

9. The power conversion system of claim 5, wherein each of the converters comprises an inductor, a switching device, a diode, and a capacitor, and wherein the at least one conversion subunit controller is configured to adjust the output voltage of each of the converters by controlling operation of the switching device of each of the converters corresponding to the at least one reference voltage.

10. The power conversion system of claim 1, wherein the at least one of the at least two conversion units is configured to be coupled to one or more loads configured to receive alternating current, and wherein the plurality of conversion subunits comprises a plurality of inverters configured to convert direct current from the at least one of the power sources to alternating current to be output to the one or more loads.

11. The power conversion system of claim 10, wherein the direct current from the at least one of the power sources is configured to be supplied to the at least one of the at least two conversion units through a DC link unit.

12. The power conversion system of claim 10, wherein the one or more loads are configured to be operated at a first alternating current power, wherein the at least one conversion subunit controller is configured to control the plurality of inverters to convert direct currents to respective alternating currents, and to adjust at least one of voltage levels, current levels, frequencies, or phases of the respective alternating currents corresponding to the first alternating current power.

13. The power conversion system of claim 12, wherein the at least one conversion subunit controller is configured to control the plurality of inverters to adjust the alternating current corresponding to the at least one reference voltage and a rectifying voltage.

14. The power conversion system of claim 13, wherein the one or more loads comprises a power grid, and wherein the at least one of the at least two conversion units further comprises a rectifying circuit configured to convert an alternating current from the power grid to a direct current to be output to the at least one of the power sources.

15. The power conversion system of claim 10, wherein each of the inverters comprises at least four switching devices and a filtering circuit comprising an inductor and a capacitor, and wherein the at least one conversion subunit controller is configured to adjust the alternating current of each of the inverters by controlling operation of at least one of the at least four switching devices of each of the inverters corresponding to the at least one reference voltage.

16. A power system comprising:
a plurality of energy storage systems each comprising a respective power conversion system as claimed in claim 10, wherein the plurality of energy storage systems are configured to be coupled to one or more power generation systems, and to be coupled to at least one of a power grid or another load; and
a master controller coupled to the energy storage systems for generating control signals corresponding to output values and/or parameters of each of the energy storage systems;
wherein the at least one output controller of each of the energy storage systems is configured to control the output values and/or parameters of the energy storage systems corresponding to the control signals.

17. The power system of claim 16, wherein the at least one output controller of one of the energy storage systems comprises the master controller.

18. A method for controlling a conversion unit of a power conversion system comprising a plurality of conversion subunits having inputs coupled to one or more power sources and outputs coupled to one another, an output controller, and at least one conversion subunit controller, the method comprising:
measuring output voltages and output currents of the plurality of conversion subunits;
computing respective power outputs of the plurality of conversion subunits corresponding to the output voltages and the output currents;
comparing the computed power outputs;
generating at least one reference voltage corresponding to the comparison of the computed power outputs generating control signals corresponding to the at least one reference voltage; and
controlling the plurality of conversion subunits corresponding to the control signals.

19. The method of claim 18, wherein the plurality of conversion subunits comprises a plurality of converters configured to convert a first direct current from the one or more power sources to a second direct current to be output to a DC link unit.

20. The method of claim 18, wherein the plurality of conversion subunits comprises a plurality of inverters configured to convert direct current from the one or more power sources to alternating current to be output to one or more loads.
